(19) United States
(12) Patent Application Publication
(10) Pub. No.: US 2024/0198421 A1
(43) Pub. Date: Jun. 20, 2024

(54) METHOD FOR PRODUCING A PRINTER NOZZLE

(71) Applicant: SCHUNK SINTERMETALLTECHNIK GMBH, Thale (DE)

(72) Inventors: André MITTELSTÄDT, Halle (DE); Christian STERTZ, Aschersleben (DE)

(73) Assignee: SCHUNK SINTERMETALLTECHNIK GMBH, Thale (DE)

(21) Appl. No.: 18/555,738

(22) PCT Filed: May 19, 2021
(86) PCT No.: PCT/EP2021/063300

§ 371 Date: Oct. 17, 2023

(51) Int. Cl. B22F 5/10; B22F 3/10; B22F 3/22; B22F 3/24; B22F 12/53; B33Y 80/00; C22C 38/02; C22C 38/04; C22C 38/18; C22C 38/44; C22C 38/48

(52) U.S. Cl. CPC B22F 5/10; B22F 3/1021; B22F 3/225; B22F 3/24; B22F 12/53; B33Y 80/00; C22C 38/02; C22C 38/04; C22C 38/18; C22C 38/44; C22C 38/48; B22F 2003/247; B22F 2003/248; B22F 2301/35; B22F 2302/10; B22F 2302/20; B22F 2302/25; B22F 2304/10; B22F 2998/10; B22F 2999/00

(57) ABSTRACT

A method for producing a printer nozzle (12, 122, 200) for dispensing a molten material, which has a nozzle body with a receiving section (20) and an outlet section (22, 222) which is, in particular, in the shape of a cone or truncated cone, characterized by the method steps of injection molding powder containing metal and sintering.

The invention relates to a method for producing a printer nozzle which dispenses molten material, in particular a printer nozzle for FFF printing, comprising a nozzle body with a receiving section and an outlet section which in particular has a cone or truncated cone shape.

The terms FFF (Fused Filament Fabrication) and FDM (Fused Deposition Modeling) refer to a filament 3D printing process in which plastic threads are melted in order to then apply layers of a 3D model to a substrate. After one layer has solidified, further layers are applied so that a body corresponding to the 3D model is ultimately created.

The basic principle of this process can be found, for example, in EP 0 833 2237 B1.

According to the prior art, the nozzles used to print the molten plastic are manufactured from a solid body by machining. Brass is an inexpensive material to consider, but it does not meet the long-term wear requirements for harder printing materials. There are therefore also nozzles made of hardened steel, stainless steel or nozzles with an insert made of polycrystalline diamond (PCD) (WO 2020/239165 A1) in order to achieve a long service life. The insert and nozzle body are separate components that are materially connected to each other.

The object of the present invention is to provide a method for producing a printer nozzle through which molten material is dispensed, in particular a printer nozzle intended for filament 3D printing, which can be produced inexpensively using a wear-resistant material. The nozzle opening, i.e. the tip region, should be able to be manufactured with high quality in order to achieve good printing results.

To solve one or more aspects, it is provided that the nozzle body is produced by injection molding metal-containing powder and sintering.

According to the invention, the metal powder injection molding process known as the MIM process is used to combine injection molding, which is known from plastics technology, with sintering, so that it is also possible to easily use wear-resistant materials that could lead to problems during machining, wherein the printer nozzle itself has a high surface quality, especially in the interior of the nozzle. There is also the possibility of changing the design by changing the injection molding tool, so that design freedom is given. The manufacturing tolerances are low due to the injection molding technology.

The nozzle openings can also be readily made with sharp edges.

The nozzle channel extending in the longitudinal direction of the nozzle body can be formed by a tool mandrel which has a conical shape on the outlet section side.

It is not absolutely necessary that the nozzle channel passes through the front region of the nozzle body. Rather, desired outlet opening diameters can be produced by machining by removing layers starting from the distal region of the outlet section. The same applies if a continuous nozzle channel is already formed during the injection process.

If, according to the prior art, as can be seen from WO 2020/239165 A1, in order to achieve high wear resistance of the nozzle outlet, a separate insert is required, which is then to be connected to the nozzle body, the invention provides in a further development that the nozzle body is manufactured at least in sections by two-component injection molding. The region of the inner channel which runs at least in sections conically on the opening side is produced as the first region in a first injection process and the remaining region as the second region of the nozzle body in a second injection step, wherein the first region is made of a material that can be more wear-resistant than that of the second region. This ensures that even when using filled plastics and those that contain encapsulated metal or possibly PCD, they can be printed with a printer nozzle that has a long service life, but at the same time the manufacturing process is quite simple. Assembling components is not necessary. A contour with tight tolerances can be achieved.

The printer nozzle according to the invention can easily be used to print molten and optionally filled plastics, ie plastics such as PLA (polyactide), ABS (acrylonitrile-butadiene-styrene copolymer), TPU (thermoplastic polyurethane) or PETG (polyethylene terephthalate), to name just a few suitable plastics, which can be filled with metal, wood, PCD, ceramic, for example.

After injection molding, a green body is removed from the tool, which body is released to produce a brown body. The brown body is then sintered, whereby the green body and/or the brown body and/or the sintered body, in particular the green body, can be machined in order to provide the desired final geometries after sintering.

The metal powder used is in particular one based on iron material. A material from the group of unalloyed steel, low-alloyed case-hardened steel, higher-alloyed ferritic steel and austenitic steel can be used.

If a low-alloy steel is used as the base component, the proportion of carbon should be between 0.1% by weight and 1.3% by weight.

The following alloying elements are particularly contained in the case of low-alloy steel, in % by weight:
0.1-1.3% C
0-2% Si
0-1% Mn
0-2% Cr
0-0.5% Mo
0-8% Ni
Residual Fe and unavoidable impurities.

The preferred alloy composition of the metal powder in % by weight for low-alloy steel is as follows:
0.7-1.1% C
0.0-0.4% Si
0.2-0.5% Mn
1.3-1.7% Cr
Residual Fe and unavoidable impurities.

With regard to higher alloy steel, the weight percentage of carbon should be between 0.01% to 2.5%, wherein at least 12% of at least one of the elements chromium or nickel are contained.

In particular, a higher alloy steel should have a composition in % by weight:
0.01-2.5% C
0-3% Si
0-3% Mn
0-40% Cr
0-3% Mo
0-45% Ni
Residual Fe and unavoidable impurities,
wherein at least 12% by weight of at least one of the elements Cr or Ni is contained.

With regard to higher-alloy steel, the preferred alloy composition in % by weight is as follows:
0.1-0.6% C
0.0-0.2% Si
18-23% Ni
22-28% Cr
1.0-1.6% Nb
Residual Fe and unavoidable impurities.

If it is possible to use the sintered body directly, if necessary after successive machining, then according to the invention there is also the possibility that the sintered body, if necessary after machining, is subjected to a heat treatment, in particular hardening such as case hardening, tempering, carbonitriding, nitriding.

Heat treatment processes for ferritic steels are known to those skilled in the art and are carried out according to specified parameters depending on the material used. Depending on the material, case hardening (carburizing or carbonitriding during annealing in the austenitic region) or tempering (consisting of hardening and tempering) can be carried out. Even with case hardening, subsequent tempering to reduce stress is common.

The region exposed to high wear may contain a metal powder the base material of which is cobalt or nickel. In particular, it is also provided that the corresponding wear-resistant first region contains hard particles, such as oxides, carbides, nitrides and/or PCD.

The proportion of hard particles in % by weight is preferably:

| | |
|---|---|
| carbides, such as WC, | 1-50% |
| oxides, such as Al₂O₃, Y₂O₃, | 0.1-5.0% |
| nitrides, such as BN, | 0.1-5.0%. |

If a nozzle according to the invention is manufactured in such a way that a different material is used in the heavily stressed region, i.e. in particular in the region of the inner channel, than in the remaining region of the nozzle, it is provided that an iron-based alloy, as described above, is used as the base material, is used for the region that is not heavily stressed, and that for the stressed region a cobalt-based or nickel-based alloy is preferably used as the second component.

In particular, it is provided that in the case of a cobalt-based alloy, one of the following compositions in % by weight is used as the second component:
0-2.0% C
0-3.5% Si
0-2.5% Mn
6-35% Cr
0-31% Mo
0-5% Ni
0-10% W
Residual Co and unavoidable impurities.

If a nickel-based alloy is used as the second component, it preferably has the following composition in % by weight:
0-0.15% C
10-25% Cr
3-10% Mo
0-6.5% Al
0-1% Ti
0-5% Nb
Residual Ni and unavoidable impurities.

Regardless of this, it is envisaged that metal particles with a numerical metal particle size distribution D₉₀=50 μm, in particular D₉₉=40 μm, are used, i.e. particles in which 90% have a size equal to or smaller than 50 μm, in particular 99% with a size equal to or smaller 40 μm.

The powder used is preferably one which contains 50% by weight to 80% by weight of metal powder and 20% by weight to 50% by weight of binder.

It should also be emphasized that as a binder at least one material from the group polyamide, polyoxymethylene, polycarbonate, styrene-acrylonitrile copolymer, polyimide, natural wax and oil, thermoset, cyanates, polypropylene, polyacetate, polyethylene, ethylene-vinyl acetate, polyvinyl-alcohols, polyvinyl chlorides, polystyrene, polymethyl methacrylates, aniline, water, mineral oil, agar, glycerin, polyvinyl butyryl, polybutyl methacrylate, cellulose, oleic acid, phthalate, paraffin, wax, especially camauba wax, ammonium, polyacrylate, diglyceride stearates and oleates, glyceryl monostearates, isopropyl titanates, lithium stearates, monoglycerides, formaldehydes, octyl acid phosphates, olefin sulfonates, phosphate esters, acid fatty alcohol esters, stearic acid, zinc stearates can be used.

As an example, it should be emphasized that a binder is used that contains the following components:
a) 10% by weight to 50% by weight of polyamide,
b) 40% by weight to 80% by weight of acid fatty alcohol esters and
c) 2% by weight to 20% by weight of an organic acid.

The invention is also characterized by a printer nozzle produced according to process steps of the type previously explained. The invention is also characterized by the use of a printer nozzle of the type previously described for filament 3D printing. In a further development of the invention, it is provided that pure plastic or filled plastic, in particular plastic filled with ceramic, renewable raw material such as wood, and/or plastic-coated metal, is printed using the printer nozzle.

Additional details, advantages and features of the invention will be apparent not only from the claims and the features specified therein, alone and/or in combination, but also from the following description of preferred exemplary embodiments illustrated in the drawings.

In the figures:

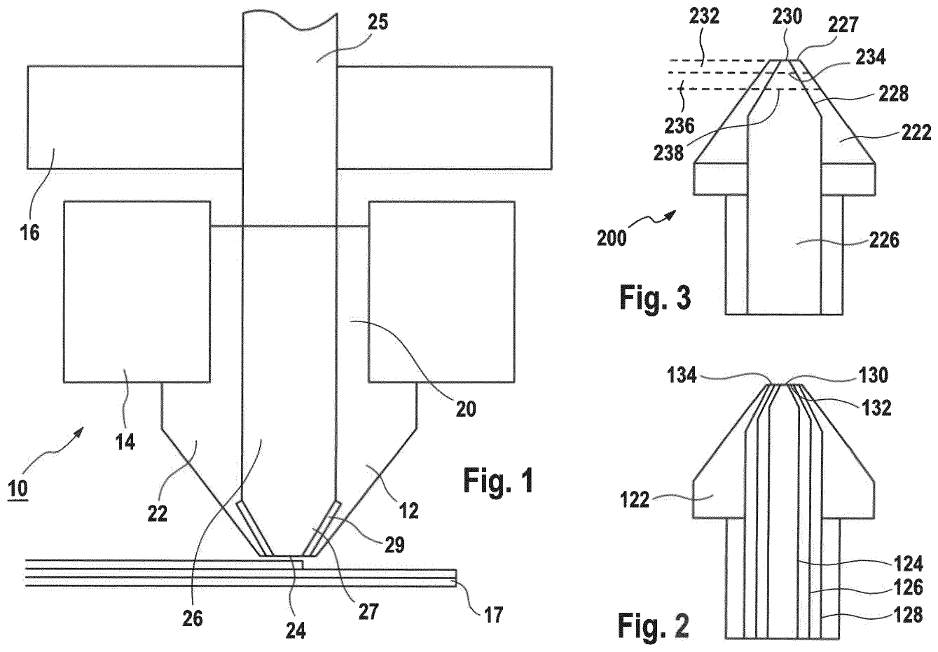

FIG. 1 shows a schematic representation of a printer head in detail and

FIGS. 2, 3 show embodiments of printer nozzles.

FIG. 1 shows a section of a printer head 10 intended for FFF printing, by means of

which molten plastic, which may be filled, is applied in layers to a substrate in order to produce a body using the additive process according to a 3D model. The printer head has a printer nozzle 12 manufactured according to the invention, which is screwed into a heating block 14. The printer nozzle 12 merges into a section 25 that guides plastic threads and is surrounded by a heat sink 16 at a distance from the heating block 14. The distance between heating block 14 and heat sink 16 serves as a heat insulator.

FIG. 1 shows several layers 17 as an example, which are successively applied onto one another, with a next layer of liquid plastic being applied onto a solidified layer.

The printer nozzle 12 consists of a nozzle body, which in turn consists of a receiving section 20 with an external thread for screwing into the section 14 and an outlet section 22 having a cone or truncated cone shape with a nozzle opening 24, through which the plastic 25 is dispensed.

In the longitudinal axis direction and coaxially surrounding the longitudinal axis, a nozzle channel 26 runs within the nozzle 12, i.e. the nozzle body, which channel tapers conically towards its distal end, i.e. towards the nozzle outlet opening 24 (section 27), as is self-explanatory from the drawing.

The nozzle 12 is manufactured using metal powder injection molding and sintering. Metal powder of a suitable alloy is kneaded with a binder to form a homogeneous powder mixture and heated.

The following process steps are used to produce the metal mixture, i.e. the feedstock:
charging the metallic and organic components,
heating, mixing, shearing to form a homogeneous mass,
discharge and, if necessary, crushing into injection-moldable granules.

The metal mixture—the feedstock—is processed in the injection molding process. For this purpose, the feedstock is injected into a closed tool at high pressure. The mold is completely filled and the feedstock is plasticized.

During injection molding, pressures between 100 bar and 2000 bar, preferably between 400 bar and 1000 bar, are used. The temperatures are between 80° C. and 280° C., preferably between 100° ° C. and 150° C.

The tool into which the feedstock is injected at high pressure should have a temperature between 10° C. and 150° C., especially between 25° C. and 35° C.

After cooling, a so-called green compact is removed from the tool in order to then debind it, for example thermally, chemically or catalytically, so that the nozzle 12 is then available as a brown compact.

Debinding can preferably be carried out in a temperature range between 40° C. and 60° ° C.

To achieve a precision molded part, sintering is then carried out at high temperatures. A hardening or tempering process can then be carried out.

Depending on the material from which the pressure nozzle 12 is made in the injection molding process, sintering takes place in the temperature range between 1150° C. and 1350° C.

Since injection molding enables close-contour production, the nozzle 12 can, if necessary, be used immediately after sintering or hardening. However, there is also the possibility of carrying out machining, which can basically take place in every step of the method, for example the green compact, the brown compact or the sintered component can be machined.

For successive machining of the printer nozzle or the nozzle bore, which depending on the embodiment should preferably have a diameter between 0.2 mm and 0.6 mm, the following should be mentioned:
metal cutting machining,
laser drilling,
wire erosion,
if necessary, surface grinding, especially of the nozzle end, ie the stop surface and the thread end, as well as
if necessary, vibratory grinding.

Preferably, standard M6 printing nozzles with a diameter of 0.2 mm, 0.4 mm and 0.6 mm are produced using the method according to the invention.

Iron material is particularly suitable as a base material for the metal powder. A material from the group of unalloyed steel, low-alloyed case-hardened steel, higher-alloyed ferritic steel and austenitic steel can be used.

There is also the possibility of making regions of the nozzle 12 particularly wear-resistant by means of two-component injection. For this purpose, corresponding regions 29, in particular the inner channel 26 in the region of the nozzle outlet 24, can be made from a material which has, for example, cobalt or nickel as the base material, wherein hard particles such as oxides, carbides, nitrides and/or polycrystalline diamond can be mixed in.

Regardless of this, the numerical particle size distribution of the metal particles should be D₉₀=50 μm, in particular D₉₉=40 μm. This means that 90% of the particles are smaller than or equal to 50 μm or 99% of the particles are equal to or smaller than 40 μm.

The feedstock to be injected should in particular contain 50 to 80% by weight of metal powder and 20 to 50% by weight of binder.

It should also be emphasized that as a binder at least one material from the group polyamide, polyoxymethylene, polycarbonate, styrene-acrylonitrile copolymer, polyimide, natural wax and oil, thermoset, cyanates, polypropylene, polyacetate, polyethylene, ethylene-vinyl acetate, polyvinyl-alcohols, polyvinyl chlorides, polystyrene, polymethyl methacrylates, aniline, water, mineral oil, agar, glycerin, polyvinyl butyryl, polybutyl methacrylate, cellulose, oleic acid, phthalate, paraffin, wax, especially carnauba wax, ammonium, polyacrylate, diglyceride stearates and oleates, glyceryl monostearates, isopropyl titanates, lithium stearates, monoglycerides, formaldehydes, octyl acid phosphates, olefin sulfonates, phosphate esters, acid fatty alcohol esters, stearic acid, zinc stearates can be used.

The inner channel 26 can be formed in the injection molding tool by means of a mandrel the outer geometry of which corresponds to the inner geometry of the inner channel, taking into account the shrinkage during debinding and in particular during sintering.

It is possible to produce the nozzle body with an inner channel and nozzle opening using the injection molding process, wherein different mandrels are used for different nozzle openings, as can be seen from FIG. 2.

The nozzle 122 can have inner channels of different diameters, indicated by lines 124, 126, 128, which channels open into openings 130, 132, 134, which have different diameters. For example, an inner channel with a diameter of 1.75 mm, bounded by line 124, or one with a diameter of 2.85 mm, bounded by line 126, opens into opening 130 with a diameter of 0.25 mm, in the opening 132 with a diameter of 0.4 mm or in the opening 132 with a diameter of 0.6 mm. Furthermore, it is possible to also reproduce internal channels of other internal diameters, which are indicated by line 128.

An alternative formation of nozzle outlet openings of different diameters is illustrated by FIG. 3. In order to achieve different opening diameters, layers are removed starting from the outlet section 222 of the nozzle 200 from the end face region 227 in order to achieve nozzle openings of different diameters, wherein the inner channel 226 is the same for all openings, while the length of the conical section 228 varies depending on the removed layers.

In the basic design of the nozzle body 200, it has an opening 230, which is, for example, of 0.25 mm. If a layer 232 is removed, the opening is enlarged in accordance with the angle of inclination of the conical section 228, resulting in a nozzle opening 234 of, for example, 0.40 mm. If a further layer 236 is removed, a larger outlet opening of, for example, 0.60 mm is created.

The manufacturing process of a printer nozzle according to the invention, with which a viscous feedstock is injected into a closed tool of an injection molding machine, is described below using an example:

Both value ranges and preferred temperatures are mentioned, which are then listed according to the claims.

1. A method for producing a printer nozzle (12, 122, 200) for dispensing molten material, in particular a printer nozzle for FFF printing, comprising a nozzle body with a receiving section (20) and an outlet section (22, 222) which is, in particular, in the shape of a cone or truncated cone,
characterized by the steps
injection molding of powder containing metal, and
sintering.

2. The method according to claim 1,
characterized in that
after the injection, the green body available is debinded and the brown body available is sintered.

3. The method according to claim 1,
characterized in that
the green body and/or the brown body and/or the sintered body, in particular the green body, are machined.

4. The method according to claim 1,
characterized in that
the nozzle body is manufactured at least in sections by two-component injection molding.

5. The method according to claim 1,
characterized in that
an inner channel (26, 226) extending in the longitudinal direction of the nozzle body is formed, which channel has a conical shape on the outlet section side.

6. The method according to claim 1,
characterized in that
the outlet section is machined by removing layers (232, 236), starting from the distal region of the outlet section (222) to achieve a desired outlet opening diameter.

7. The method according to claim 1,
characterized in that
the injection molding is carried out using a tool with a tool mandrel, the geometry of which corresponds to at least the inner channel (26, 226) to be produced, in particular the inner channel and outlet opening (24, 130, 230) to be produced.

8. The method according to claim 1,
characterized in that
the two-component injection molding produces a first region (29) of the nozzle body, which preferably delimits the conical region (27) of the inner channel (26) at least partially, and a second region, wherein for the first region a material is used that is more wear-resistant than that of the second region.

9. The method according to claim 1,
characterized in that
a powder based on iron materials is used as the powder.

10. The method according to claim 1,
characterized in that
at least one material from the group of unalloyed steel, low-alloyed case-hardened steel, higher-alloyed ferritic steel and austenitic steel is used as the iron base material.

11. The method according to claim 1,
characterized in that
a low-alloy steel is one with at least 0.1% by weight to 1.3% by weight of carbon, especially one with the following alloying elements in % by weight
0.1-1.3% C
0-2% Si
0-1% Mn
0-2% Cr
0-0.5% Mo
0-8% Ni
residual Fe and unavoidable impurities,
is used.

12. The method according to claim 1,
characterized in that
a higher alloy steel is one with a proportion by weight of carbon between 0.01% and 2.5% and at least 12% of at least one of the elements chromium and nickel, in particular one with the alloying elements
0.01-2.5% C
0-3% Si
0-3% Mn
0-40% Cr
0-3% Mo
0-45% Ni
residual Fe and unavoidable impurities,
wherein at least 12% by weight of at least one of the elements Cr or Ni is contained,
is used.

13. The method according to claim 1,
characterized in that
a low-alloy steel with an alloy composition of the metal powder in % by weight is used as follows:
0.7-1.1% C
0.0-0.4% Si
0.2-0.5% Mn
1.3-1.7% Cr
residual Fe and unavoidable impurities.

14. The method according to claim 1,
characterized in that
a low-alloy steel with an alloy composition of the metal powder in % by weight is used as follows:
0.1-0.6% C
0.0-0.2% Si
18-23% Ni
22-28% Cr
1.0-1.6% Nb
residual Fe and unavoidable impurities.

15. The method according to claim 1,
characterized in that
the sintered body, if necessary after machining, is subjected to a heat treatment, in particular hardening, such as case hardening, tempering, carbonitriding, nitriding.

16. The method according to claim 1,
characterized in that
the powder used for the first region (29) of the printer nozzle (12, 122, 200) is one with a material based on the group of cobalt and nickel.

17. The method according to claim 1,
characterized in that
that hard particles such as oxides, carbides, nitrides and/or PCD are mixed into the base material, in particular that for the first region (29) of the printer nozzle (12, 122, 200).

18. The method according to claim 1,
characterized in that
hard particles are used in % by weight of the mixture of hard particles and base material:

| | |
|---|---|
| carbides, such as WC, | 1-50% |
| oxides, such as Al₂O₃, Y₂O₃, | 0.1-5.0% |
| nitrides, such as BN, | 0.1-5.0% |

19. The method according to claim 1,
characterized in that
metal particles of a numerical metal particle size distribution D₉₀=50 μm, in particular D₉₉=40 μm, are used.

20. The method according to claim 1,
characterized in that
the powder used is preferably one which contains 50% by weight to 80% by weight of metal powder and 20% by weight to 50% by weight of binder.

21. The method according to claim 1,
characterized in that
as a binder at least one material from the group polyamide, polyoxymethylene, polycarbonate, styrene-acrylonitrile copolymer, polyimide, natural wax and oil, thermoset, cyanates, polypropylenes, polyacetates, polyethylenes, ethylene-vinyl acetates, polyvinyl-alcohols, polyvinyl chlorides, polystyrene, polymethyl methacrylates, aniline, water, mineral oil, agar, glycerin, polyvinyl butyryl, polybutyl methacrylate, cellulose, oleic acid, phthalate, paraffin, wax, in particular carnauba wax, ammonium, polyacrylate, diglyceride stearates and oleates, glyceryl monostearates, isopropyl titanates, lithium stearates, monoglycerides, formaldehydes, octyl acid phosphates, olefin sulfonates, phosphate esters, acid fatty alcohol esters, stearic acid, zinc stearates is used.

22. The method according to claim 1,
characterized in that
that a binder is used that contains the following components:
a) 10% by weight to 50% by weight of polyamide,
b) 40% by weight to 80% by weight of acid fatty alcohol esters, and
c) 2% by weight to 20% by weight of an organic acid.

23. A printer nozzle (12, 122, 200) manufactured according to claim 1.

24. Use of a printer nozzle (12, 122, 200) according to claim 23 for filament 3D printing (FFF printing).

25. Use according to claim 24, wherein pure plastic or filled plastic, in particular plastic filled with ceramic, renewable raw material such as wood, and/or plastic-coated metal, is printed using the printer nozzle (12, 122, 200).
